(19) United States
(12) Patent Application Publication
(10) Pub. No.: US 2026/0024184 A1
(43) Pub. Date: Jan. 22, 2026

(54) IMAGE PROCESSING METHOD, PROCESSOR, AND NON-TRANSITORY COMPUTER READABLE STORAGE MEDIUM

(71) Applicant: Realtek Semiconductor Corporation, Hsinchu (TW)

(72) Inventors: Shi-Hao LI, Hsinchu (TW); Pao-Chi YEH, Hsinchu (TW)

(21) Appl. No.: 19/093,291

(22) Filed: Mar. 28, 2025

(30) Foreign Application Priority Data
Jul. 19, 2024 (TW) 113127185

(51) Int. Cl. G06T 5/92; G06T 5/50; G06T 11/00; G06V 20/00; G06V 40/10

(52) U.S. Cl. CPC G06T 5/92; G06T 5/50; G06T 11/00; G06V 20/35; G06V 40/10; G06T 2207/10048; G06T 2207/20016; G06T 2207/20021

(57) ABSTRACT

An image processing method includes following operations: receiving a visible-light image; receiving an infrared image; determining a shooting scene according to the infrared image; determining whether to perform a high dynamic range processing on the visible-light image according to the shooting scene; and when it is determined to perform the high dynamic range processing on the visible-light image, generating and outputting a high dynamic range image for a back-end system to display.

### RELATED APPLICATIONS

This application claims priority to Taiwanese Application Serial Number 113127185, filed Jul. 19, 2024, which is herein incorporated by reference.

### BACKGROUND

### Technical Field

The present disclosure relates to image processing technology. More particularly, the present disclosure relates to an image processing method, a processor, and a non-transitory computer readable storage medium that can more accurately determine whether to perform the high dynamic range (HDR) processing on an image.

### Description of Related Art

With developments of technology, many electronic devices are equipped with image sensors to capture dynamic images or static images. In some related approaches, high dynamic range (HDR) can be utilized to improve image quality. However, when high dynamic range processing is performed incorrectly, it may cause images to be overexposed or cause images to be over-processed.

### SUMMARY

Some aspects of the present disclosure are to provide an image processing method. The image processing method includes following operations: receiving a visible-light image; receiving an infrared image; determining a shooting scene according to the infrared image; determining whether to perform a high dynamic range processing on the visible-light image according to the shooting scene; and generating and outputting a high dynamic range image for a back-end system to display when it is determined to perform the high dynamic range processing on the visible-light image.

Some aspects of the present disclosure are to provide a processor. The processor includes a processing circuit. The processing circuit is configured to receive a visible-light image and an infrared image, determine a shooting scene according to the infrared image, and determine whether to perform a high dynamic range processing on the visible-light image according to the shooting scene. When it is determined to perform the high dynamic range processing on the visible-light image, the processing circuit outputs a high dynamic range image for a back-end system to display.

Some aspects of the present disclosure are to provide a non-transitory computer readable storage medium. The non-transitory computer readable storage medium stores one or more computer programs. The one or more computer programs comprise a plurality of instructions. When a processor executes the plurality of instructions, the processor performs following operations: receiving a visible-light image; receiving an infrared image; determining a shooting scene according to the infrared image; determining whether to perform a high dynamic range processing on the visible-light image according to the shooting scene; and generating and outputting a high dynamic range image for a back-end system to display when it is determined to perform the high dynamic range processing on the visible-light image.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an electronic device according to some embodiments of the present disclosure.

FIG. 2 is a flow diagram of an image processing method according to some embodiments of the present disclosure.

FIG. 3 is a schematic diagram of an infrared image according to some embodiments of the present disclosure.

FIG. 4 is a schematic diagram of multiple shooting scenes according to some embodiments of the present disclosure.

FIG. 5 is a schematic diagram of an electronic device according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

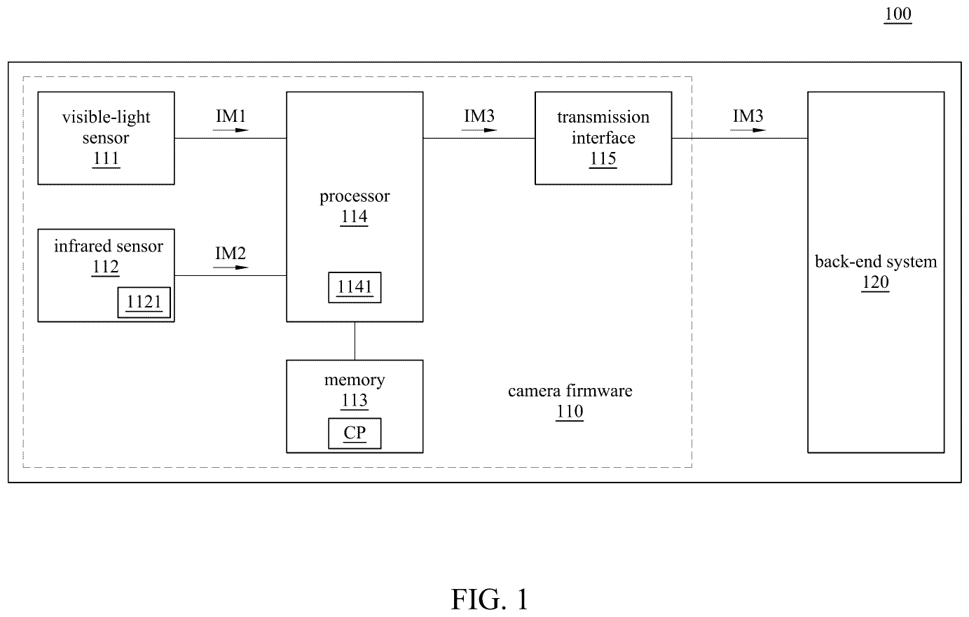

Reference is made to FIG. 1. FIG. 1 is a schematic diagram of an electronic device 100 according to some embodiments of the present disclosure. In some embodiments, the electronic device 100 is a laptop computer, but the present disclosure is not limited thereto. The electronic device 100 can be other various electronic devices.

As illustrated in FIG. 1, the electronic device 100 includes camera firmware 110 and a back-end system 120. The camera firmware 110 is coupled to the back-end system 120.

In the example that the electronic device 100 is the laptop computer, the camera firmware 110 can be hardware and software responsible for capturing images and processing images in the laptop computer. The back-end system 120 can be other hardware and software in the laptop computer. For example, the back-end system 120 can include a system processor, a system memory, a display panel, input and output devices, computer programs stored in the system memory, or other hardware and software.

The camera firmware 110 includes a visible-light sensor 111, an infrared sensor 112, a memory 113, a processor 114, and a transmission interface 115. The visible-light sensor 111 is coupled to the processor 114. The infrared sensor 112 is coupled to the processor 114. The memory 113 is coupled to the processor 114. The transmission interface 115 is coupled between the processor 114 and the back-end system 120.

The visible-light sensor 111 is configured to capture a visible-light image IM1. The visible-light sensor 111 can include a lens and a visible-light sensing component. In the example that the electronic device 100 is the laptop computer, the visible-light sensor 111 can be disposed in a front lens of the laptop computer, but the present disclosure is not limited thereto. The visible-light sensor 111 can be disposed in a back lens or a lens at other position of the laptop computer.

The infrared sensor 112 is configured to capture an infrared image IM2. The infrared sensor 112 can include an infrared source 1121, a lens, and an infrared sensing component. In the example that the electronic device 100 is the laptop computer, the infrared sensor 112 can be disposed in a front lens of the laptop computer, but the present disclosure is not limited thereto. The infrared sensor 112 can be disposed in a back lens or a lens at other position of the laptop computer.

The memory 113 is configured to store one or more computer programs CP. Each computer program CP includes multiple instructions. The memory 113 can be implemented by a non-transitory computer readable storage medium. The non-transitory computer readable storage medium is, for example, a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains.

The processor 114 is configured to receive the visible-light image IM1 and the infrared image IM2, and perform the instructions in the computer programs CP to perform image processing on the visible-light image IM1 and the infrared image IM2. The processor 114 can include one or more processing circuits 1141. The processing circuit 1141 can be an image signal processor (ISP) circuit.

The transmission interface 115 is configured to transmit data processed by the processor 114 to the back-end system 120. The transmission interface 115 can be a universal serial bus (USB) terminal, but the present disclosure is not limited thereto.

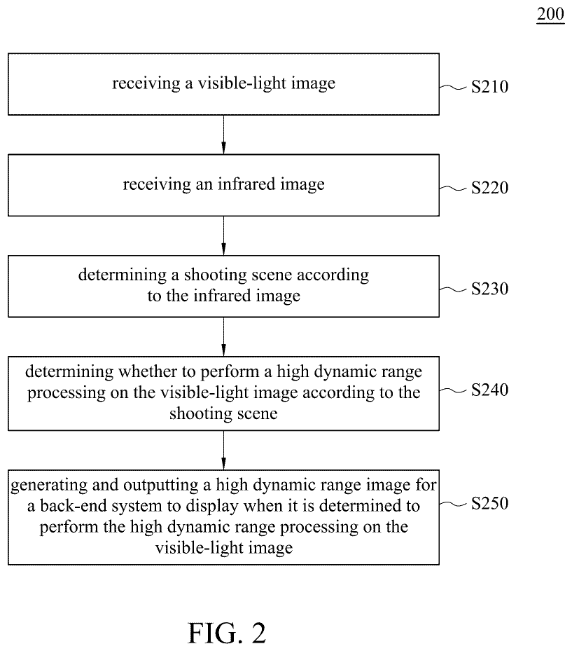

References are made to FIG. 1 and FIG. 2. FIG. 2 is a flow diagram of an image processing method 200 according to some embodiments of the present disclosure.

In some embodiments, the image processing method 200 is applied to the electronic device 100 in FIG. 1, but the present disclosure is not limited thereto. For better understanding, following paragraphs are described with FIG. 1.

In practical applications, when the processing circuit 1141 in the processor 114 executes the instructions in the computer program CP, the processing circuit 1141 performs the image processing method 200. As illustrated in FIG. 2, the image processing method 200 includes operation S210, operation S220, operation S230, operation S240, and operation S250.

In operation S210, the processing circuit 1141 receives the visible-light image IM1. For example, when a user or the system turns on the visible-light sensor 111, the visible-light sensor 111 can capture current environment to generate the dynamic or static image visible-light image IM1, and transmit the visible-light image IM1 to the processing circuit 1141. The visible-light image IM1 is with a first resolution and a first frame per second (FPS). The first resolution can be, for example, 1920×1080 ultra-high quality resolution, the first FPS can be, for example, 30, but the present disclosure is not limited to these values.

In operation S220, the processing circuit 1141 receives the infrared image IM2. For example, when the visible-light sensor 111 captures the current environment, the infrared sensor 112 can simultaneously capture the current environment to generate the dynamic or static infrared image IM2, and transmit the infrared image IM2 to the processing circuit 1141 in background of the system. The infrared image IM2 is with a second resolution and a second FPS. In some embodiments, the second resolution is lower than the aforementioned first resolution, and the second FPS is lower than the aforementioned first FPS. The second resolution can be, for example, 400×200, the second FPS can be, for example, 3, but the present disclosure is not limited to these values. In some applications, the infrared sensor 112 captures the current environment when the infrared source 1121 is turned off. In this situation, the infrared image IM2 includes one or more dark images.

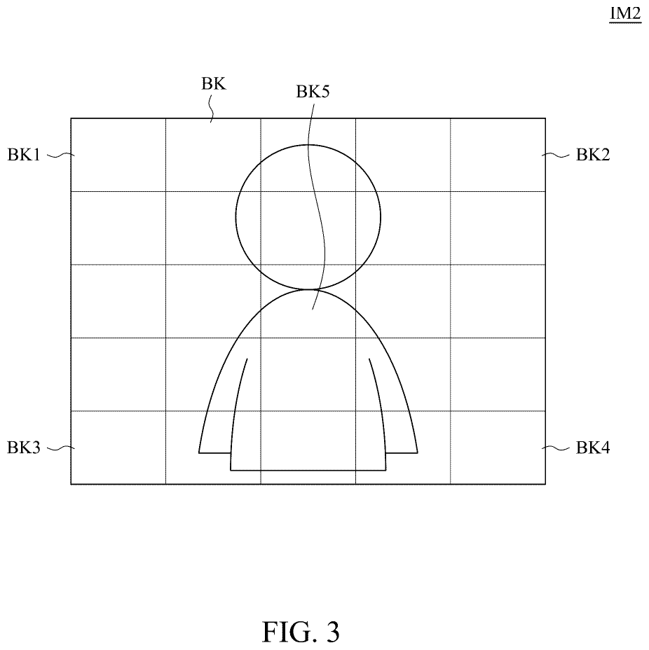

In operation S230, the processing circuit 1141 determines a shooting scene according to the infrared image IM2. In the applications above, the processing circuit 1141 determines the shooting scene according to the one or more dark images. References are made to FIG. 2 and FIG. 3. FIG. 3 is a schematic diagram of the infrared image IM2 according to some embodiments of the present disclosure.

First, the processing circuit 1141 divides the infrared image IM2 into multiple blocks BK. As illustrated in FIG. 3, the infrared image IM2 is divided into 25 blocks BK, but the present disclosure is not limited thereto.

Then, the processing circuit 1141 calculates average brightness values of the blocks BK. Taking the block BK1 as an example, the processing circuit 1141 can perform an average calculation on brightness values of all pixels in the block BK1 to generate the average brightness value of the block BK1. Other blocks have similar content, so they are not described herein again.

Then, the processing circuit 1141 determines the shooting scene (reflecting conditions of the current environment) according to the average brightness values of the blocks BK.

In some embodiments, the processing circuit 1141 determines a brightness distribution of the infrared image IM2 according to positions of the blocks BK and the average brightness values of the blocks BK at first. For example, the processing circuit 1141 can determine the brightness distribution of the infrared image IM2 according to the average brightness values of the blocks BK at corner positions (e.g., including at least the block BK1, the block BK2, the block BK3, the block BK4) and the average brightness value of the block at a central position (e.g., including at least the block BK5), but the present disclosure is not limited thereto. Then, the processing circuit 1141 determines the shooting scene of the infrared image IM2 according to the brightness distribution.

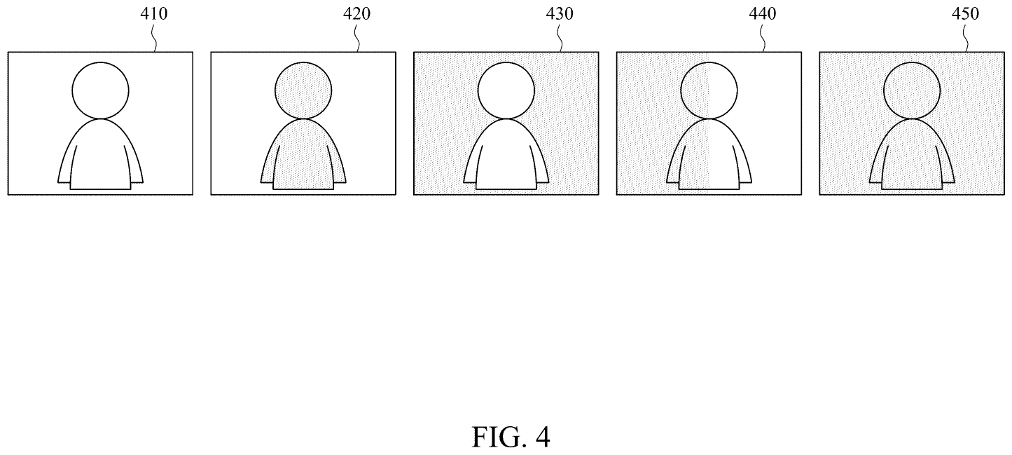

References are made to FIG. 2 and FIG. 4. FIG. 4 is a schematic diagram of multiple shooting scenes according to some embodiments of the present disclosure. As illustrated in FIG. 4, types of the shooting scene can include an outdoor scene 410, a back-to-light scene 420, a face-to-light scene 430, a side-to-light scene 440, and an indoor scene 450.

In some embodiments, the processing circuit 1141 determines a block quantity according to the average brightness values of the blocks BK and a brightness threshold at first. For example, when the average brightness value of each of M blocks is higher than a first brightness threshold, the processing circuit 1141 determines that the high-brightness block quantity is M. When the average brightness value of each of N blocks is lower than a second brightness threshold (the second brightness threshold is lower than the first brightness threshold), the processing circuit 1141 determines that the low-brightness block quantity is N. Then, the processing circuit 1141 determines the shooting scene of the infrared image IM2 according to the block quantity above.

In operation S240, the processing circuit 1141 determines whether to perform high dynamic range (HDR) processing on the visible-light image IM1 according to the shooting scene. References are made to FIG. 2 and FIG. 4. For example, the processing circuit 1141 can determine whether the shooting scene of the infrared image IM2 is the indoor scene 450. When the processing circuit 1141 determines that the shooting scene of the infrared image IM2 is not the indoor scene 450, the processing circuit 1141 performs the high dynamic range processing on the visible-light image IM1. In other words, when the processing circuit 1141 determines that the shooting scene of the infrared image IM2 is the outdoor scene 410, the back-to-light scene 420, the face-to-light scene 430, or the side-to-light scene 440, the processing circuit 1141 performs the high dynamic range processing on the visible-light image IM1. Since sunlight brightness of the outdoor scene 410, the back-to-light scene 420, the face-to-light scene 430, or the side-to-light scene 440 is stronger, it easily causes bright parts of images to be overexposed or loss details of dark parts of images. The high dynamic range processing can, by composing multiple images with different exposure conditions, generate a final image to retain both of details of bright parts and details of dark parts, thereby obtaining an image with a wider dynamic range.

In operation S250, when the processing circuit 1141 determines to perform the high dynamic range processing on the visible-light image IM1, the processing circuit 1141 performs the high dynamic range processing on the visible-light image IM1 to generate and output a high dynamic range image IM3 for the back-end system 120 to display. As illustrated in FIG. 1, the processing circuit 1141 can transmit the high dynamic range image IM3 to the back-end system 120 through the transmission interface 115. Then, the high dynamic range image IM3 can be displayed by the display panel in the back-end system 120 for a user to view or perform other processing.

In addition to high dynamic range processing, the processing circuit 1141 can also perform a visible-light image processing (e.g., removing noise or enhancing edges) on the visible-light image IM1 to improve image quality.

In some related approaches, when the high dynamic range processing is performed incorrectly (e.g., not performed when needed, or performed when not needed), it may cause images to be overexposed or cause images to be over-processed. For example, when the shooting location is an office and the office includes a white wall, due to high brightness and high contrast of the white wall, it is easy misjudged to perform the high dynamic range processing. This causes images to be over-processed. In addition, when the shooting location is an office and the office includes a side light source, it is easy misjudged not to perform the high dynamic range processing. This causes images to be overexposed.

Compared to the related approaches above, the present disclosure utilizes the infrared image IM2 to determine the shooting scene at first, and then determines whether to perform the high dynamic range processing on the visible-light image IM1 according to the shooting scene. Since the infrared image IM2 contains more accurate sunlight information, the shooting scene can be determined more accurately. Thus, whether to perform the high dynamic range processing on the visible-light image IM1 can be determined more accurately, thereby improving visibility of the final image.

In addition, many existing electronic devices are already equipped with both of the visible-light sensor 111 and the infrared sensor 112. These existing electronic devices can achieve operations above without adding additional hardware components.

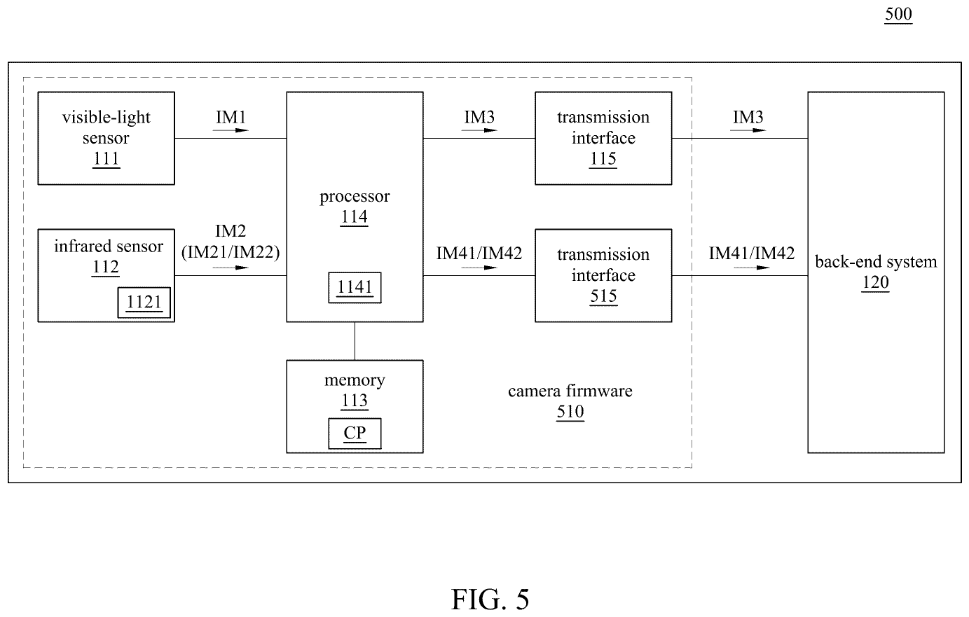

FIG. 5 is a schematic diagram of an electronic device 500 according to some embodiments of the present disclosure.

References are made to FIG. 1 and FIG. 5. An architecture of the electronic device 500 is similar to the architecture of the electronic device 100. One of major differences between the electronic device 500 and the electronic device 100 is that, camera firmware 510 of the electronic device 500 further includes a transmission interface 515. The transmission interface 515 is coupled between the processor 114 and the back-end system 120.

In some applications, the infrared sensor 112 captures the current environment when the infrared source 1121 is turned on and turned off alternately (e.g., being turned on, off, on, off, on, off sequentially). The alternating interval can be one frame. The infrared image IM2 generated in this situation includes one or more bright images IM21 and one or more dark images IM22. The infrared image IM2 in FIG. 5 is with a third resolution and a third FPS. In some embodiments, the third resolution is higher than the second resolution of the infrared image IM2 (the infrared source 1121 is turned off) in FIG. 1, and the third FPS is higher than the second FPS of the infrared image IM2 (the infrared source 1121 is turned off) in FIG. 1.

References are made to FIG. 2 and FIG. 5. In operation S230, the processing circuit 1141 determines the shooting scene according to the infrared image IM2. In the applications above, the processing circuit 1141 determines the shooting scene according to the one or more dark images IM22. When the shooting scene is determined, the processing circuit 1141 performs operation S240 and operation S250. Details about operation S240 and operation S250 are described in aforementioned paragraphs, so they are not described herein again.

In addition, the processing circuit 1141 can perform an infrared image processing (e.g., removing noise or enhancing edges) on the one or more bright images IM21 and the one or more dark images IM22 to generate and output one or more processed bright images IM41 and one or more processed dark images IM42. Then, the processing circuit 1141 transmits the one or more processed bright images IM41 and the one or more processed dark images IM42 to the back-end system 120 through the transmission interface 515 for the back-end system 120 to perform a biometric recognition function. The biometric recognition function is, for example, a face recognition function. The face recognition function can be, for example, Windows Hello, but the present disclosure is not limited thereto. For example, the back-end system 120 can perform a subtracting operation on the processed bright images IM41 and the processed dark images IM42 to remove the background and obtain face depth information. Then, the back-end system 120 can perform the face recognition function according to the face depth information to determine whether to allow the user to log into the system.

As described above, the image processing method, the processor, and the non-transitory computer readable storage medium in the present disclosure can utilize the infrared image to determine the shooting scene to determine whether to perform the high dynamic range processing on the visible-light image more accurately, thereby improving the visibility of the final image.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image processing method, comprising:
receiving a visible-light image;
receiving an infrared image;
determining a shooting scene according to the infrared image;
determining whether to perform a high dynamic range processing on the visible-light image according to the shooting scene; and
generating and outputting a high dynamic range image for a back-end system to display when it is determined to perform the high dynamic range processing on the visible-light image.

2. The image processing method of claim 1, wherein determining the shooting scene according to the infrared image comprises:
dividing the infrared image into a plurality blocks;
calculating a plurality of average brightness values of the plurality of blocks; and
determining the shooting scene according to the plurality of average brightness values.

3. The image processing method of claim 2, wherein determining the shooting scene according the plurality of average brightness values comprises:
determining a brightness distribution according a plurality of positions of the plurality of blocks and the plurality of average brightness values; and
determining the shooting scene according to the brightness distribution.

4. The image processing method of claim 3, wherein the plurality of positions comprise a plurality of corner positions and a central position.

5. The image processing method of claim 2, wherein determining the shooting scene according the plurality of average brightness values comprises:
determining a block quantity according to the plurality of average brightness values and a brightness threshold; and
determining the shooting scene according to the block quantity.

6. The image processing method of claim 1, wherein determining whether to perform the high dynamic range processing on the visible-light image according to the shooting scene:
determining whether the shooting scene is an indoor scene; and
performing the high dynamic range processing on the visible-light image when it is determined that the shooting scene is not the indoor scene.

7. The image processing method of claim 1, wherein the infrared image is captured when an infrared source is turned off and the infrared image comprises a dark image, wherein determining the shooting scene according to the infrared image comprises:
determining the shooting scene according to the dark image.

8. The image processing method of claim 7, wherein the visible-light image is with a first resolution and a first frame per second (FPS), and the infrared image is with a second resolution and a second FPS, wherein the second resolution is lower than the first resolution, and the second FPS is lower than the first FPS.

9. The image processing method of claim 1, wherein the infrared image is captured when an infrared source is turned on and turned off alternately and the infrared image comprises a bright image and a dark image, wherein the image processing method further comprises:
performing an infrared image processing on the bright image and the dark image to generate a processed bright image and a processed dark image; and
outputting the processed bright image and the processed dark image for the back-end system to perform a biometric recognition function.

10. A processor, comprising:
a processing circuit configured to receive a visible-light image and an infrared image, determine a shooting scene according to the infrared image, and determine whether to perform a high dynamic range processing on the visible-light image according to the shooting scene,
wherein when it is determined to perform the high dynamic range processing on the visible-light image, the processing circuit outputs a high dynamic range image for a back-end system to display.

11. The processor of claim 10, wherein the processing circuit is further configured to divide the infrared image into a plurality blocks, calculate a plurality of average brightness values of the plurality of blocks, and determine the shooting scene according to the plurality of average brightness values.

12. The processor of claim 11, wherein the processing circuit is further configured to determine a brightness distribution according a plurality of positions of the plurality of blocks and the plurality of average brightness values, and determine the shooting scene according to the brightness distribution.

13. The processor of claim 12, wherein the plurality of positions comprise a plurality of corner position and a central position.

14. The processor of claim 11, wherein the processing circuit is further configured to determine a block quantity according to the plurality of average brightness values and a brightness threshold, and determine the shooting scene according to the block quantity.

15. The processor of claim 10, wherein the processing circuit is further configured to determine whether the shooting scene is an indoor scene,
wherein when it is determined that the shooting scene is not the indoor scene, the processing circuit performs the high dynamic range processing on the visible-light image.

16. The processor of claim 10, wherein the infrared image is captured when an infrared source is turned off and the infrared image comprises a dark image,
wherein the processing circuit is further configured to determine the shooting scene according to the dark image.

17. The processor of claim 16, wherein the visible-light image is with a first resolution and a first FPS, and the infrared image is with a second resolution and a second FPS, wherein the second resolution is lower than the first resolution, and the second FPS is lower than the first FPS.

18. The processor of claim 10, wherein the infrared image is captured when an infrared source is turned on and turned off alternately and the infrared image comprises a bright image and a dark image,
wherein the processing circuit is further configured to perform an infrared image processing on the bright image and the dark image to generate a processed bright image and a processed dark image, and output the processed bright image and the processed dark image for the back-end system to perform a biometric recognition function.

19. The processor of claim 10, wherein the processor is further coupled to a visible-light sensor and an infrared sensor to receive the visible-light image and the infrared image.

20. A non-transitory computer readable storage medium storing one or more computer programs, wherein the one or more computer programs comprise a plurality of instructions, wherein when a processor executes the plurality of instructions, the processor performs following operations:
receiving a visible-light image;
receiving an infrared image;
determining a shooting scene according to the infrared image;
determining whether to perform a high dynamic range processing on the visible-light image according to the shooting scene; and
generating and outputting a high dynamic range image for a back-end system to display when it is determined to perform the high dynamic range processing on the visible-light image.
